(19) United States
(12) Patent Application Publication
(10) Pub. No.: US 2016/0187172 A1
(43) Pub. Date: Jun. 30, 2016

(54) ULTRASONIC VISCOMETER

(71) Applicant: Cameron International Corporation, Houston, TX (US)

(72) Inventor: Emanuel J. Gottlieb, Pittsburgh, PA (US)

(21) Appl. No.: 14/585,773

(22) Filed: Dec. 30, 2014

(51) Int. Cl. G01F 1/66; G01N 11/02; E21B 47/10

(52) U.S. Cl. CPC G01F 1/667; E21B 47/101; G01N 11/02

(57) ABSTRACT

An ultrasonic flowmeter for detecting fluid flow rates using transit time measurement, including an upstream transducer positioned so plane waves generated by the upstream transducer propagates through the flowmeter and a downstream transducer positioned so plane waves generated by the downstream transducer propagates through the flowmeter to generate an upstream transducer signal and a downstream transducer signal. The flowmeter further includes sensors which measure either upstream and downstream temperature and/or pressure, thus, providing measurements of fluid density. The flowmeter as described provides a simple and cost effective way to calculate fluid viscosity using Poiseuille's equation in real time.

This section is intended to introduce the reader to various aspects of art that may be related to various aspects of the presently described embodiments. This discussion is believed to be helpful in providing the reader with background information to facilitate a better understanding of the various aspects of the described embodiments. Accordingly, it should be understood that these statements are to be read in this light and not as admissions of prior art.

In the petroleum industry, viscosity is often a key characteristic used to understand a fluid environment. For example, the viscosity of crude oil can inform how difficult or easy it is going to be to pump the oil out of the ground. Other examples where viscosity is very frequently measured include monitoring chemical fluid injection in subsea oil wells, measuring downhole hydrocarbon viscosities, and sampling and blending applications of fluids. The petroleum industry is not the only industry that relies upon viscosity measurements to assure proper process controls. Other areas in which viscosity is often relied upon include monitoring the manufacturing of food products, for example, chocolate or tomato sauce production, paint products, cosmetic compositions, polymer coatings, consumer products, for example, detergents or lotions, or any other fluid for which flow is an important consideration. All of these areas would benefit from a simplified structure that effectively evaluates viscosity.

Industry currently uses ultrasonic meters to measure the flow rate of a fluid. It has been discovered that these ultrasonic flowmeters may be modified to further be viscometers. Typical ultrasonic flowmeter arrangements use two transducers at opposing ends of a pipe where one is upstream from the fluid flow and other is downstream from the fluid flow, both transducers transmit and receive signals. See, for example, U.S. Pat. No. 8,245,581 which is assigned to Cameron International Corporation. Each transducer generates plane waves into the fluid and surrounding pipe wall. The difference in transit times between the upstream signal and the downstream signal is used to calculate the flow rate. While current flowmeters can measure fluid flow rates, they cannot measure fluid density or fluid viscosity.

The present invention allows the measurement of fluid density in the same ultrasonic flowmeter used to measure the flow rate. With fluid density and fluid flow rate, viscosity may be calculated. To allow measurement of fluid density, an ultrasonic flowmeter is further equipped with either temperature or pressure sensors, or both. Temperature sensors measure upstream and downstream temperature and can be placed before or after one or more transducers. Pressure sensors may be disposed upstream and downstream, both or after transducers. According to one embodiment pressure sensors are disposed between the transducers.

The viscometer as described herein can be used in any process in which an ultrasonic flowmeter would currently be useful, as well as new areas where the ultrasonic flowmeter would not have been used heretofore because flow rate alone was not of interest. While, the invention will be described as it relates to oil wells, the invention is not so limited and is equally useful in other fluid systems where viscosity information is desired. The inclusion of pressure sensors in the ultrasonic flowmeter creates a simple and effective method for ascertaining viscosity that is more accurate than prior art methods.

### BRIEF DESCRIPTION OF THE DRAWING

In the accompanying drawings, the preferred embodiment of the invention and preferred methods of practicing the invention are illustrated in which:

FIG. 1 shows a flowmeter of the present invention.

FIG. 2 shows an acoustic signal path.

FIG. 3 shows another embodiment of the flowmeter arrangement including noise dampening.

FIG. 4 shows an alternative flowmeter embodiment including a flow conditioner to adjust turbulent flow.

FIG. 5 shows another flowmeter embodiment including a tubular flow conditioner to adjust turbulent flow.

FIG. 6 shows an alternative flowmeter arrangement including multiple pipes or tubes having associated ultrasonic transducers.

FIGS. 7A-7F represent alternative flowmeter configurations that can be used in the described embodiments.

### DESCRIPTION

The following discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function, unless specifically stated. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. In addition, the terms “axial” and “axially” generally mean along or parallel to a central axis (e.g., central axis of a body or a port), while the terms “radial” and “radially” generally mean perpendicular to the central axis. The use of “top,” “bottom,” “above,” “below,” and variations of these terms is made for convenience, but does not require any particular orientation of the components.

As used herein, references to the “present invention” or “invention” relate to exemplary embodiments and not necessarily to every embodiment encompassed by the appended claims.

Fluid viscosity has often been measured by automated viscometers that are complex, expensive and unwieldy. Other viscometers such as glass capillary viscometers are common to the industry. These viscometers require the technician to sample the fluid offline in order to make a measurement. The present invention provides a simple solution to obtaining real time viscosity for fluids in the viscosity range of from about 1 to about 5,000 cst. The present invention provides an ultrasonic viscometer and a method for determining viscosity that is simple and cost effective using Poiseuille's equation.

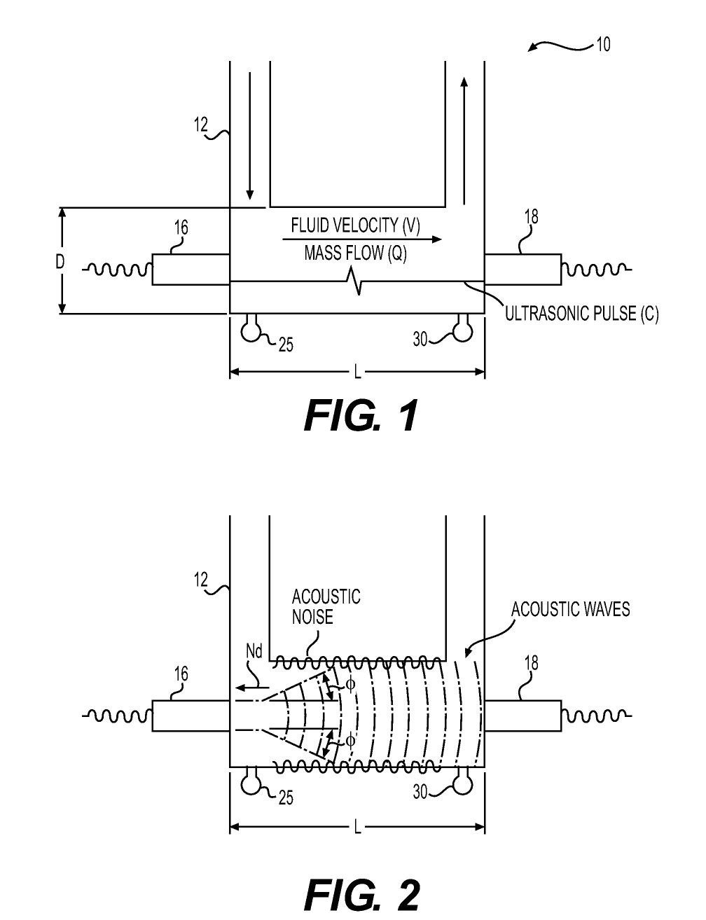

Referring now to the drawings wherein like reference numerals refer to similar or identical parts throughout the several views, and more specifically to FIG. 1 thereof, there is shown a flowmeter 10 for detecting fluid flow rates in a pipe 12. The flowmeter 10 comprises an upstream ultrasonic transducer 16 in contact with the pipe 12 and positioned in alignment with the pipe so plane waves generated by the upstream transducer 16 propagate through the pipe. The flowmeter 10 comprises a downstream ultrasonic transducer 18 in contact with the pipe 12 and positioned so plane waves generated by the downstream transducer 18 propagate through the pipe. The downstream transducer 18 receives the plane waves from the upstream transducer 16 and provides a downstream transducer 18 signal. The upstream transducer 16 receives the plane waves from the downstream transducer 18 and produces an upstream transducer 16 signal. The transducer signals represent the time that it takes the plane waves traveling through the fluid to arrive at the opposite transducer 16 or 18, respectively. From this information, in conjunction with information regarding the fluid and the transducers, the controller can calculate the fluid flow rate.

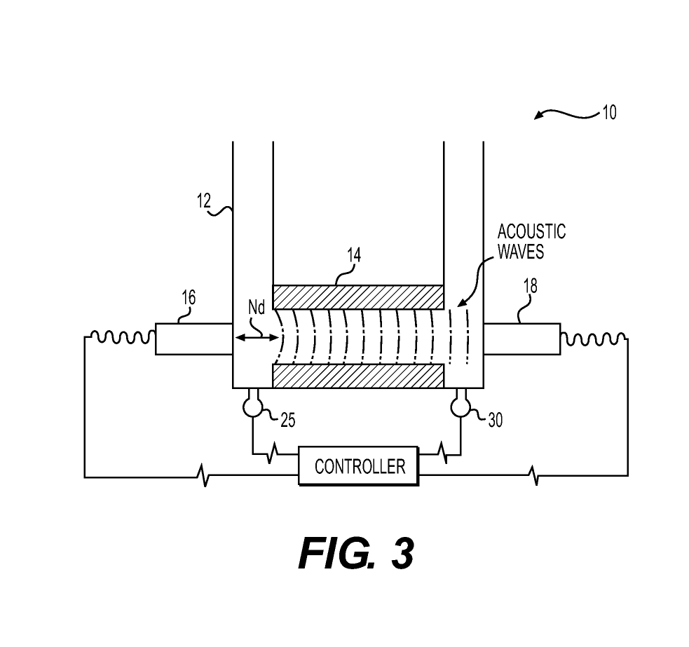

The flowmeter 10 also comprises a controller (seen in FIG. 3) in communication with the upstream 16 and downstream transducers 18 which calculates fluid flow rate from the upstream transducer 16 signal and the downstream transducer 18 signal. The flowmeter 10 further comprises an upstream sensor 25 and a downstream sensor 30 for measuring the temperature or differential pressure of the fluid as it passes between the transducers. The sensors 25 and 30 create a signal that is communicated to the controller. In one embodiment, the flowmeter 10, can further include both temperature sensors along with the pressure sensors (not shown).

Pressure sensors are commercially available and selection of appropriate sensors would be readily apparent to the skilled artisan. Sensors for use in the method as described can be chosen from any art recognized sensor including but not limited to piezoresistive strain gauges, capacitive sensors, magnetic sensors, piezoelectric sensors, optical sensors, potentiometric sensors, resonant sensors, etc. According to one embodiment, the pressure sensor is selected to be a Rosemount 3051S differential pressure meter.

Temperature sensors are also commercially available and selection of appropriate temperature sensors would be readily apparent to the skilled artisan. Temperature sensors for use in the method as described can be electrical, for example a thermocouple or a thermistor or a resistance thermometer, or they can be mechanical sensors, for example, a thermometer.

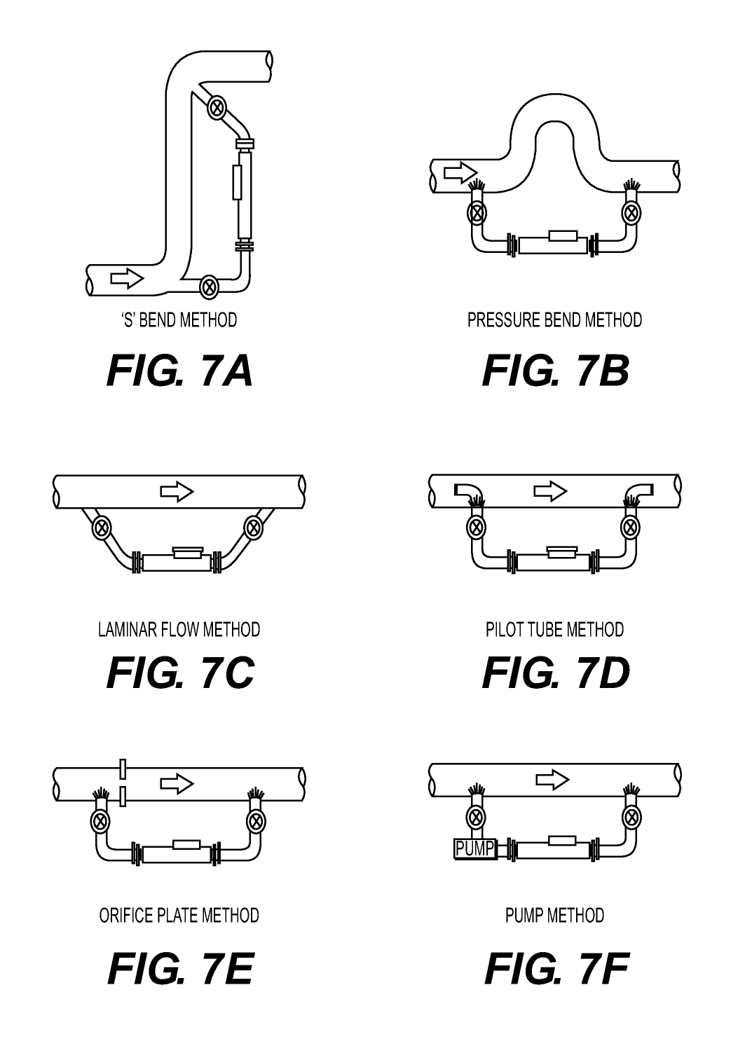

While FIGS. 1-6 depict embodiments of a flowmeter in the form of a bypass type U-shaped ultrasonic flowmeter where a sample of the fluid of interest is diverted from the main fluid flow into the U-shaped pipe 12 and then back into the main fluid flow, the configuration of the flowmeter can be altered as will be understood by the skilled artisan. As can be seen in FIGS. 7A-7F, flowmeters for use in the methods described herein can take a variety of shapes. For example, in FIG. 7A, the flowmeter is directionally integrated into the main fluid flow and receives a fluid sample as the main flow is diverted in a S-bend pipe FIG. 7B shows a flowmeter that samples the fluid before a pressure bend in the pipe. The pressure bend causes a slight increase in pressure before the bend, making sampling of the fluid possible. FIG. 7C depicts an in-line flowmeter that replies upon the angled entry of the flowmeter to sample the fluid stream while maintaining laminar flow. FIG. 7D represents a flowmeter that takes sample through a tube that has been extended into the main fluid flow, which tube has been bent to direct the tube's openings into line with the direction of the fluid flow. FIG. 7E represents a flowmeter with a sampling system that relies upon an orifice plate to pool the liquid in the main pipe over the opening of the sampling pipe. Finally, FIG. 7F shows a flowmeter that samples from the main fluid flow through the use of a pump to draw the fluid into the flowmeter.

Embodiments further relate to a method for measuring fluid density in a pipe 12 and ascertaining fluid viscosity. The method comprises flowing fluid through pipe 12, generating plane waves by an upstream transducer 16 in contact with the pipe 12 and positioned in alignment with the pipe so the plane waves propagate through the pipe and are received by a downstream transducer 18, which produces a downstream transducer 18 signal. Plane waves are also generated by the downstream transducer 18 in contact with the pipe 12 and positioned so the plane waves propagate through the pipe and are received by the upstream transducer 16, which produces an upstream transducer 16 signal. The upstream sensor 25 and the downstream sensor 30 measure at least one of temperature or pressure of the fluid flowing through the pipe and produce output signals indicative of the fluid condition measured. Finally, the transducer signals and sensor signals are sent to a controller, which uses the signals to calculate viscosity, density, and flow rate.

In operation, the ultrasonic flowmeter uses two wetted transducers at opposing ends of a pipe 12 where one is upstream from the fluid flow and the other is downstream from the fluid flow, both transducers transmit and receive signals (FIG. 1). The difference in transit times between the upstream and downstream signal is used to calculate the flow rate. Each transducer generates plane waves into the fluid and surrounding pipe 12 wall (FIG. 2).

For FIG. 1:

$${t}_{d} = \frac{L}{C + V}$$

$${t}_{u} = \frac{L}{C - V}$$

$$Δ t = {t}_{u} - {t}_{d}$$

$$V = \frac{{c}^{2} Δ t}{2 L}$$

V is velocity

C is speed of sound in liquid

t is time

tᵤ is the upstream transit time

t_{d} is the downstream transit time

Δt is the transit time difference

L is the length of the pipe

In order to solve for the speed of sound in fluid and fluid velocity, the upstream and downstream transit times need to be measured via a controller. The controller computes the transit time differences between the upstream and downstream flow. The Δt is then used to calculate the fluid velocity for a given flowmeter length “L” for a calculated speed of sound “C”. Once the velocity “V” has been calculated then the Mass Flow Q can be determined since the area “A” of the fluid opening or pipe 12 is known.

For FIG. 2:

$$ϕ = {sin}^{- 1} ( \frac{.61 λ}{r} )$$

$$Nd = \frac{{r}^{2}}{λ}$$

$$λ = \frac{c}{f}$$

λ=wavelength

Nd: focal length

r is the radius of the transducer

f is frequency

When sound diverges it diverges at angle φ. It then propagates into the wall of pipe 12, which is received by the opposing transducer as noise. This acoustic noise arrives at a time preceding the sound that travels in the liquid since sound velocities in the solid are higher than those in the fluid. According to one embodiment in the event the noise is significant and interferes with the accuracy of the flow measurements, the pipe 12 can be fitted with a dampening tube 14. The tube 14 with acoustically attenuative properties can be inserted within the pipe 12 (FIG. 3). The opening in the tube 14 acts as conduit for the fluid and the fluid path for sound, while the surrounding area acts as sound absorber. After the sound travels through the tube 14 it begins to spread again but this has no effect on the signal to noise ratio therefore the surrounding sound absorber successfully disables the pipe 12 noise. An example of such an attenuated device can be found in U.S. Pat. No. 8,806,734.

Unlike prior art flowmeters, the flowmeter as described further comprises physical sensors 25, 30 to measure the density of the fluid. The density of the fluid can be calculated based on a speed of sound and temperature correlation or it can be measured by means of a pressure sensor. If calculating the density (ρ) of the fluid based upon the temperature (T) and the speed or sound, the following correlation may be used:

$$C ( T ) = \sqrt{\frac{K + \frac{3}{4} G}{ρ}}$$

where K is the bulk modulus of the fluid and G is the shear modulus of the fluid.

The physical sensors 25, 30 can be either pressure sensors or temperature sensors or both. While only a single sensor is shown in FIGS. 1-3, the flowmeter may contain separate temperature and pressure sensors or may include a multitude of pressure or temperature sensors as desired. With the addition of these sensors, the flowmeter 10 is also a densitometer. Sensors are generally located to measure the desired characteristic at the upstream end of the pipe 12 and at the downstream end of the pipe 12. When the sensors 25 and 30 include pressure sensors, the sensors are preferably located between the transducers 16, 18. Signals provided by the sensors 25, 30 are communicated to the controller. The controller can, based upon the information collected, calculate one or more of the fluid flow rate, the fluid density, and the fluid viscosity, either dynamic or kinematic.

According to one embodiment fluid density is ascertained from the measurements taken by the differential pressure sensors 25 and 30. Once density and flow rate have been measured, the viscosity of the fluid may be calculated.

Using Poiseuille's equation, assuming the fluid flow is laminar viscous and incompressible, the fluid is passed through a cylindrical pipe where the length of the pipe is greater than its diameter.

$$Q = \frac{πΔ {Pr}^{4}}{8 L η}$$

Q is the volumetric flow rate

L is the length of the pipe

η is the dynamic viscosity

r is the pipe radius

π is the mathematical constant.

Since Q=Area×Velocity and r=D/2 then rearranging the equation and solving for dynamic viscosity yields:

$$η = \frac{Δ {PD}^{2}}{32 L V}$$

D is the pipe diameter

V is the fluid velocity

Finally, the kinematic viscosity, V is:

$$V = \frac{η}{ρ} = \frac{Δ {PD}^{2}}{32 L v}$$

The flowmeter/densitometer/viscometer described herein can be used in industrial processes where one wants to know or control the system viscosity, for example, when one wants to blend a variety of fluids and wants to control the final fluid viscosity.

### EXAMPLES

Poiseuille's equation can theoretically be used to calculate dynamic viscosity given other physically measured parameters such as volume flow rate and pressure difference in pipes with flowing fluid. According to the following examples dynamic viscosity was calculated from a time of flight ultrasonic velocity measurement in a single path configuration using two opposing transducers in a small pipe (less than one inch diameter). Furthermore, the kinematic viscosity was calculated by dividing the dynamic viscosity by the density of the fluid, in this case propylene glycol. These examples were carried out to calculate the ΔP for a given flow rate Q in order to establish that it is realistic to make such viscosity measurements on hydrocarbons.

Using Poiseuille's equation and solving for ΔP yields:

$$Δ P = \frac{8 Q L η}{π {r}^{4}}$$

Propylene glycol was selected as the test fluid having a dynamic viscosity of 0.404 Poise @ 25° C., a density of 1.036 g/cm³, and a kinematic viscosity of 39 cst. Based on the following information: r=0.5″=1.27 cm; L=12″=30.48 cm; η=0.404 Poise @ 25° C.; the ΔP was calculated for various flow rates. Note: 1 mmHg=1333 dynes/cm².

### Example 1

For a flow rate of Q=1600 L/hr=4444 cm³/s, the ΔP was 53566 dynes/cm² which equals 40.18 mmHg. The Reynolds number (Re) was 5,715.20.

### Example 2

For a flow rate of Q=600 BPH=95 m³/hr=26,388 cm³/s, the ΔP was 318,073 dynes/cm² which equals 238 mmHg. The Reynolds number was 33,941.

### Example 3

For a flow rate of Q=150 L/hr=41 cm³/s, the ΔP was 494 dynes/cm² which equals 0.37 mmHg. The Reynolds number was 53.

Based upon the flow rate Q and the pressure drop, the Reynolds Number was calculated for each system. The Reynolds number can be calculated using the following equation:

$$Re = \frac{ρ v D}{η}$$

Based on the calculations above, only example 3 has a Re<2300. Accordingly, Example 3 is the only example that maintained a laminar flow pattern. Measurements made using the pressure differential across sensors are, like known ultrasonic flowmeters, Reynolds number dependent. Flowmeters according to the instant disclosure will vary in size and configuration depending upon the particular application and fluid to be measured. As is well understood by the skilled artisan, less turbulence will be present at lower flow rates or in smaller pipes. So, in order to use the 12″ by 1″ pipe flowmeter to measure the viscosity of propylene glycol, the flow rate of the system Q has to be 1788 cm³/s or less to maintain laminar flow, i.e., a Reynolds number below 2300.

Based upon the foregoing discussion, the skilled artisan would understand how to modify the flowmeter or calculate the maximum flow rate so as to maintain laminar flow and thereby ascertain the fluid viscosity. When Re>2300 then flow conditioners would have to be used or other mathematical adaptations of Poiseuille's equation based on fluid dynamics.

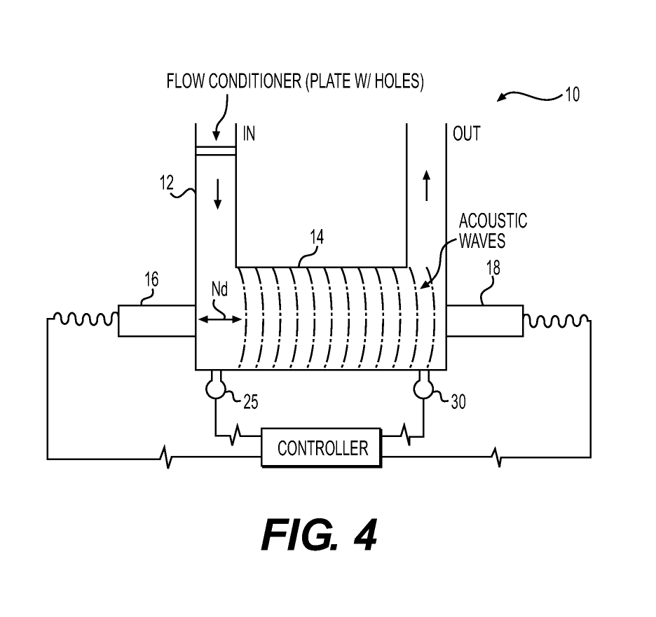

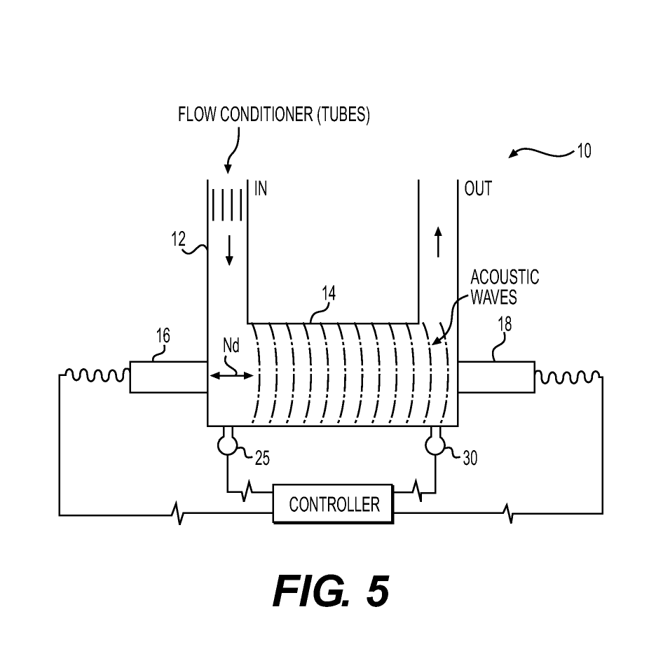

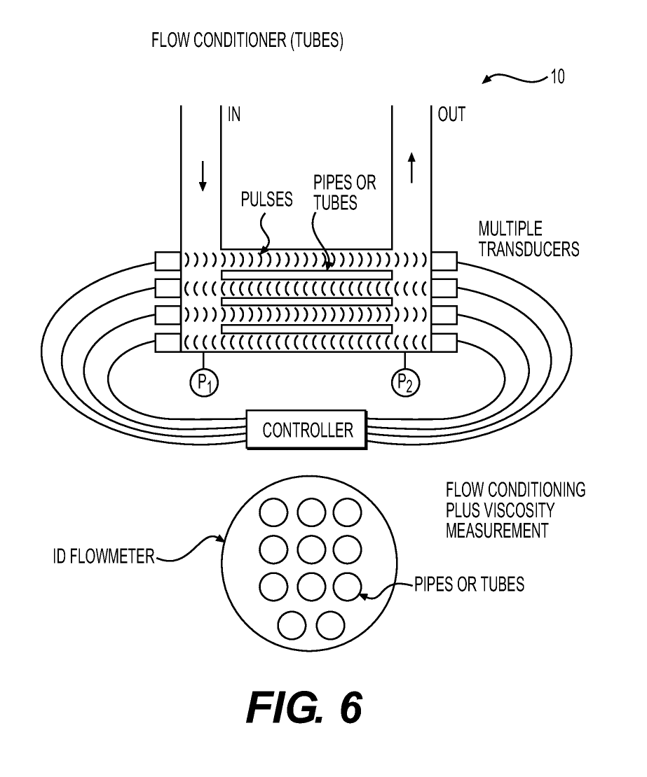

A variety of flow conditioner options can be seen in FIGS. 4 to 6. FIG. 4 depicts the fluid entering the flowmeter 10 and passing through an orifice plate, which is simply a plate having holes through which the fluid can flow prior to entering the transducer space as the center of the pipe. In FIG. 5, the orifice plate conditioner is replaced with a multi-tube conditioner. The fluid flows into the flowmeter 10 through the tubes which condition the flow and make it more laminar before the fluid moves into the transducer space. As used herein, transducer space refers to the area of the flowmeter that is between the upstream transducer 16 and the downstream transducer 18. As can be seen in FIG. 6, flow conditioning can be accomplished by tubes that are in the transducer space and are configured to be in the direction of flow.

A cross section view of one tube arrangement according to the embodiment depicted in FIG. 6, can be seen below the controller. In this embodiment, FIG. 6, the flowmeter may be made up of more than two transducers. The flowmeter can have a series of transducer pairs to obtain more accurate fluid flow characteristics. Also, as seen in the embodiment of FIG. 6, the sensors are designated as pressure sensors, P1 and P2. While pressure sensors can be preferred in this configuration temperature sensors could work equally well in this embodiment.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

Other embodiments of the present invention can include alternative variations. These and other variations and modifications will become apparent to those skilled in the art once the above disclosure is fully appreciated. It is intended that the following claims be interpreted to embrace all such variations and modifications.

What is claimed is:

1. A meter for detecting flow rates and density of a fluid comprising:
a pipe through which the fluid flows;
an upstream ultrasonic transducer configured to propagate ultrasonic waves through the pipe;
a downstream ultrasonic transducer configured to propagate ultrasonic waves through the pipe and positioned to receive the ultrasonic waves propagated by the upstream ultrasonic transducer;
wherein the upstream ultrasonic transducer is positioned to receive the ultrasonic waves propagated by the downstream ultrasonic transducer;
an upstream sensor to measure the upstream temperature or upstream pressure of the fluid, the upstream sensor providing an upstream sensor signal;
a downstream sensor to measure the downstream temperature or downstream pressure of the fluid, the downstream sensor providing a downstream sensor signal; and
a controller in communication with the upstream and downstream transducers and sensors configured to receive the signals that calculates at least one of flow rate, density, and viscosity of the fluid.

2. The flowmeter as described in claim 1 wherein the sensors comprise pressure sensors.

3. The flowmeter as described in claim 1, wherein the sensors comprise temperature sensors.

4. The flowmeter as described in claim 1, wherein the flow meter is chosen from at least one of a U-shaped flowmeter, an S-bend flowmeter, a pressure bend flowmeter, a laminar flow flowmeter, a pilot tube flowmeter, an orifice plate flowmeter or a pump flowmeter and wherein the flowmeter is configured to accept a sample of the fluid.

5. The flowmeter as described in claim 1, wherein the controller is configured to use Poiseuille's equation to calculate one or more of dynamic viscosity or kinematic viscosity as follows:
$$Q = \frac{Δ P π {r}^{4}}{8 η l}$$
Q is the volumetric flow rate,
L is the length of the pipe,
η is the dynamic viscosity,
r is the pipe radius,
π is the mathematical constant,
solving for dynamic viscosity η using Q=Area×Velocity and r=D/2 yields:
$$η = \frac{Δ {PD}^{2}}{32 L V}$$
D is the pipe diameter,
V is the fluid velocity,
solving for kinematic viscosity, v yields:
$$υ = \frac{η}{ρ} = \frac{Δ {PD}^{2}}{32 ρ L V}$$

6. The flowmeter as described in claim 1, further comprising at least two pairs of transducers.

7. The flowmeter as described in claim 1, further comprising a fluid conditioner.

8. The flowmeter as described in claim 7, wherein the fluid conditioner is chosen from at least one of an orifice plate or a tubular insert to condition flow.

9. A method for detecting fluid viscosity in a pipe, comprising:
flowing fluid through a pipe;
propagating ultrasonic plane waves through the fluid in the pipe from an upstream location;
propagating ultrasonic plane waves through the fluid in the pipe from the downstream location;
measuring the upstream ultrasonic plane waves from a downstream location to produce a signal;
measuring the downstream ultrasonic plane waves from the upstream locations to produce a signal;
measuring at least one of pressure and temperature of the fluid from a second upstream location;
measuring at least one of pressure and temperature of the fluid from a second downstream location;
using the upstream and downstream pressure or temperature measurements to calculate, with a controller, at least one of flow rate, density, and viscosity of the fluid.

10. The method as described in claim 9 wherein the sensors are pressure sensors.

11. The method as described in claim 9, wherein the sensors are temperature sensors.

12. The method as described in claim 10, further comprising
configuring the controller to use Poiseuille's equation to calculate one or more of dynamic viscosity or kinematic viscosity as follows:
$$Q = \frac{πΔ {Pr}^{4}}{8 L η}$$
Q is the volumetric flow rate,
L is the length of the pipe,
η is the dynamic viscosity,
r is the pipe radius,
π is the mathematical constant,
solving for dynamic viscosity η using Q=Area×Velocity and r=D/2 yields:
$$η = \frac{Δ {PD}^{2}}{32 L V}$$
D is the pipe diameter,
V is the fluid velocity,
solving for kinematic viscosity, v yields:
$$υ = \frac{η}{ρ} = \frac{Δ {PD}^{2}}{32 ρ L V}$$

13. The method as described in claim 9, wherein the generating plane waves by the upstream transducer includes generating the plane waves by the upstream transducer so that essentially all non-fluid paths of sound are absorbed by a tube, the generating plane waves by the downstream transducer step includes the step of generating the plane waves by the downstream transducer so that essentially all non-fluid paths of sound are absorbed by the tube.

14. The method as described in claim 9, further comprising at least two pairs of transducers.

15. The method as described in claim 9, further comprising a fluid conditioner.

16. The method as described in claim 15, wherein the fluid conditioner is chosen from at least one of an orifice plate or a tubular insert to condition flow.

17. A method for monitoring the fluid viscosity of a fluid in a wellbore comprising:
sampling a fluid to be examined;
measuring the flow rate with at least two ultrasonic transducers;
measuring the density of the fluid with a pair of pressure sensors; and
using Poiseuille's equation to calculate one or more of dynamic viscosity or kinematic viscosity.

18. The method of claim 17, wherein the sampling is done using a flowmeter chosen from at least one of a U-shaped flowmeter, an S-bend flowmeter, a pressure bend flowmeter, a laminar flow flowmeter, a pilot tube flowmeter, an orifice plate flowmeter or a pump flowmeter.

19. The method of claim 17, wherein the fluid to be examined is a hydrocarbon.

20. The method of claim 17, wherein the wellbore is a subsea well.

21. The method of claim 10, wherein the ultrasonic flowmeter measures viscosity in real time using Poiseuille's equation for the chemical injection of fluids into a wellbore.

22. The method of claim 10, wherein the ultrasonic flowmeter measures viscosity in real time using Poiseuille's equation for the sampling and blending of fluids.

23. The method of claim 10, wherein the ultrasonic flowmeter for real time fluid viscosity measurement using Poiseuille's equation measures the fluid viscosity in the viscosity range of from about 1 to about 5,000 cst.

24. The method of claim 10, wherein the pressure sensors are chosen for at least one of piezoresistive strain gauges, capacitive sensors, magnetic sensors, piezoelectric sensors, optical sensors, potentiometric sensors, resonant sensors.

25. The method of claim 11, wherein the temperature sensors are chosen from at least one of a thermocouple, a thermistor, a resistance thermometer, or a thermometer.

26. The method of claim 10, wherein the ultrasonic flowmeter is operated in one or more of the following configurations, an ‘S’ bend method, pressure bend method, laminar flow method, pilot tube method, orifice plate method, and pump method.
